(19) United States
(12) Patent Application Publication
(10) Pub. No.: US 2009/0303084 A1
(43) Pub. Date: Dec. 10, 2009

(54) METHOD AND APPARATUS FOR PROVIDING VISIBLE INDICATION OF ELEVATED AIRPORT LIGHT COLOR

(75) Inventors: Russell Lewis Tartock, Springfield, IL (US); Albert Boyd Cable, Springfield, IL (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: Honeywell International

(21) Appl. No.: 12/136,627

(22) Filed: Jun. 10, 2008

(51) Int. Cl. B64F 1/18

(52) U.S. Cl. 340/953

(57) ABSTRACT

Method and apparatus for providing visible indication of elevated airport light color during a non-operation condition. A set of light emitting diodes (LEDs) can be assembled to a housing of an elevated airport light. The housing and the set of LEDs can be covered by a clear glass, wherein the clear glass can be designed to cover some or an entire external region of the housing. Multiple colored tapes can be applied to a vertical portion of the housing such that, for example, a minimum of two-and-half square inches of the tape is visible from different angles. Therefore, the colored tapes can provide a clear visible indication of the elevated airport light color during a non-operation condition without the need for expensive colored glass and/or lens.

### TECHNICAL FIELD

Embodiments are generally related to airport runway light systems and installations. Embodiments are also related to elevated airport lights for airport runway light systems. Embodiments are also related to elevated airport and heliport lights for use in airport runway light and heliport touchdown and lift-off (TLOF)/final approach and take-off (FATO) lighting systems. Embodiments are additionally related to techniques for providing visible indication of elevated airport lights during non-operational conditions.

### BACKGROUND OF THE INVENTION

Lighting systems are essential navigational aids for aircraft, boats, and other vehicles. Such lighting systems provide guidance, signaling and demarcation functions. Modern airports incorporate numerous specialized elevated lighting systems for illuminating the edge of an airport runway, taxiway and parking areas in order to minimize the possibility that an aircraft may inadvertently travel off the edge of a runway or taxiway. Typical elevated lighting systems include, but are not limited to, runway edge lighting, runway threshold lighting, runway end lighting, and taxiway edge lighting systems. Elevated lights located in the runway edges can be specially designed to define runways and taxiways, and inhibit pilots from inadvertently maneuvering airplanes off designated runways and taxiways.

An elevated light usually includes a housing that is attached to a mast. The mast is firmly fastened via a frangible coupling to a base plate, which is embedded into the surface of the ground. A typical housing may include the use of light emitting diodes (LEDs), which receive power from a power supply through the mast. The mast projects upward from the frangible coupling in the base plate and supports the LEDs above the surface of the ground in order to provide elevated lighting. An electrical plug may also be provided at the bottom of the mast to couple the electrical wiring of the LEDs to a main line of the airport lighting system.

Moreover, the airport lighting system can exhibit a set of regulations to be maintained in the assembly of the elevated airport light. Some regulations dictate that, during daytime viewing or other times when the assembly is not in operation, a minimum colored surface area of, for example, two-and-half square inches, shall be visible from any direction that indicates the color of the light emitted during operation. The majority of prior art elevated airport lights utilize a colored lens to filter the full spectrum incandescent/halogen bulb light output to meet color requirements and, therefore, comply with this regulation. With the advent of LED technology, the use of filtering colored glass was no longer required but was still employed in order to meet the regulations. In addition, some of the prior art elevated lights can also utilize a colored glass, a clear lens and different colored LEDs in order to produce a family of lights. Such a colored lens and/or glass configuration, and the color LEDs, are more expensive, which increases the overall cost of the elevated airport lights. Therefore, it is desirable to provide a means for indicating the elevated airport light color at a lower cost.

In an effort to address the foregoing difficulties, it is believed that a need exists for an improved method for providing visible indication of elevated airport light color, which meets required regulations without the need for expensive colored glass and/or lens. It is believed that the approach disclosed herein can address these and other continuing needs.

### BRIEF SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the present invention to provide for an improved elevated airport light for use with airport runway light systems.

It is another aspect of the present invention to provide for an improved method and apparatus for providing visible indication of elevated airport light color.

The aforementioned aspects and other objectives and advantages can now be achieved as described herein. An improved method and apparatus for providing visible indication of elevated airport light color during a non-operation condition, is disclosed. A set of light emitting diodes (LEDs) can be assembled to a housing of an elevated airport light. A clear glass may be assembled to the housing and the set of LEDs can be completely covered by the clear glass. Multiple colored tapes can be applied to a vertical portion of the lamp housing such that a minimum of, for example, two-and-half square inches of the tape is visible from different angles. Therefore, the use of colored tapes can provide a clear visible indication of the elevated airport light color during a non-operational condition and without the need for expensive colored glass and/or lens.

Furthermore, the LEDs can be elevated above a surface of the ground with the help of a mast that is mounted to a base plate via a frangible coupling. The color of the colored tapes is generally the color of the light emitted from the LEDs. The colored tape may be reflective or non-reflective, but may not be retro-reflective. The colored tapes can also be applicable to bi-directional elevated lights, where the tape can be of one color on one side of the elevated light and a different color on the other side of the elevated light. Such a technique can also be accomplished by applying paint to an appropriate area of the housing, in the event that the housing shape does not permit the application of the colored tape. Hence, regulations can be met by substituting clear glass and colored tapes for the more expensive colored glass. Further cost savings may be achieved through the “economy of scale”, wherein the number of clear glass covers purchased will be greater than the individual numbers of the various colored glass covers.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates a schematic view of an elevated airport light for an airport runway light system, in accordance with a preferred embodiment;

FIG. 2 illustrates an elevation view of another elevated airport light with colored tapes, in accordance with an alternative embodiment;

FIG. 3 illustrates a top view of the elevated airport light as shown in FIG. 2, in accordance with an alternative embodiment;

FIG. 4 illustrates a top plan view of an airport runway light system incorporating the airport elevated lights constructed and arranged in accordance with a preferred embodiment;

FIG. 5 illustrates a flow chart of operations depicting logical operational steps of a method for providing visible indication of elevated airport light color, in accordance with a preferred embodiment; and

FIG. 6 illustrates a top plan view of a heliport landing area lighting system incorporating elevated airport lights constructed and arranged in accordance with an alternative embodiment.

### DETAILED DESCRIPTION

The particular values and configurations discussed in these non-limiting examples can be varied and are cited merely to illustrate at least one embodiment and are not intended to limit the scope thereof.

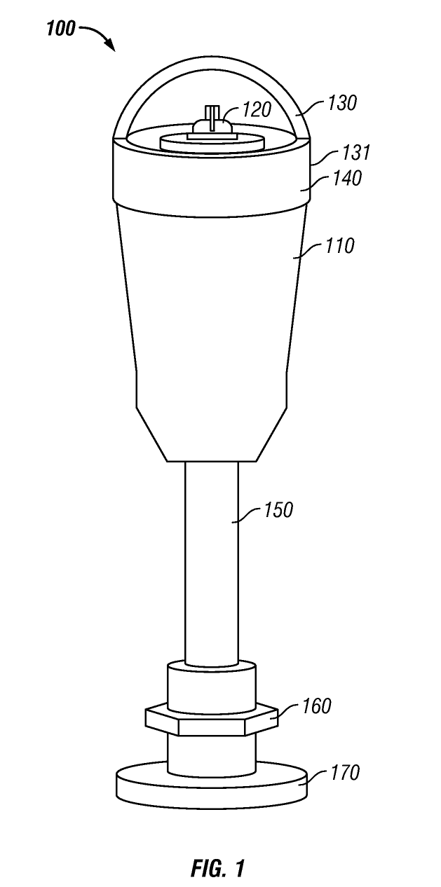

FIG. 1 illustrates a schematic view of an elevated airport light 100 for an airport runway light system 400, in accordance with a preferred embodiment. The elevated airport light 100 comprises a housing 110 elevated above the surface of ground by utilizing a mast 150. The housing 110 can incorporate a set of light emitting diodes (LEDs) 120 that is secured at the mast 150. The mast 150 can be mounted to a base plate 170 through a frangible coupling 160. Note that the embodiments discussed herein generally relate to airport runway light systems 400, as illustrated in FIG. 4. It can be appreciated, however, that such embodiments can be implemented in the context of other lighting systems and designs and are not limited to the airport runway light system 400. The discussion of airport runway light systems 400, as utilized herein, is presented for general illustrative purposes only.

The mast 150 and the base plate 170 can provide a source of power through a power coupler (not shown) by utilizing a set of electrical wires (not shown). The mast 150 can be designed as hollow to allow the electrical wires between the LEDs 120 in the housing 110 and the base plate 170. The power coupler can further be connected with a main power line (not shown) in the airport runway light system 400. Such a power coupler can provide the required power to the LEDs 120 via the mast 150. The mast 150 secures to the base plate 170 via the frangible coupling 160 to provide a stable support for the housing 110 during harsh weather conditions or other conditions impacting operation and/or orientation of the elevated airport light 100. The frangible coupling 160 enables an easy breakaway of the mast 150 from the base plate 170 when an airplane 450, as illustrated in FIG. 4, maintenance vehicle or other forces exert a predetermined pressure on the frangible coupling 160 sufficient to cause breaking thereof.

Moreover, the housing 110 further comprises a clear colorless glass 130 at its top for permitting the transmission of, and possible directing of, the light emitted from the LED light source 120. Several colored tapes 140 can be applied to a vertical portion 131 of the housing 110, such that a minimum portion of, for example, two-and-half square inches, of the tape 140 is visible from different angles. The color of the colored tape 140 is the color of the light emitted from the LED light source 130. These colored tapes 140 can be generally utilized in automotive applications and other markets. Such a colored tape can provide a clear visible indication of the elevated airport light color during a non-operation condition without the need for expensive colored glass and/or lens.

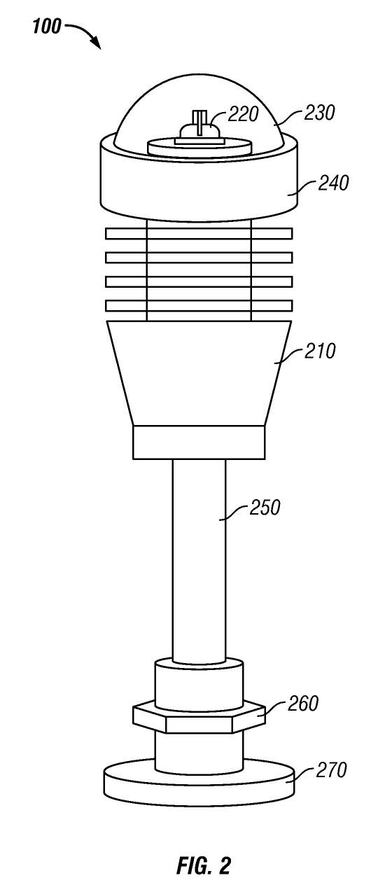

FIG. 2 illustrates an elevation view of another elevated airport light 200 with colored tapes 240, in accordance with an alternative embodiment. The elevated airport light 200 comprises a set of LEDs 220 that can be assembled within a housing 210. The LEDs 220 can be elevated above a surface of ground utilizing a mast 250 that is attached to a base plate 270 via a frangible coupling 260. The housing 210 can be shaped in a circular manner, especially in spring-like manner, as illustrated in FIG. 2, depending upon design considerations. It can be appreciated, of course, that other shapes may be utilized to implement the housing 210. The housing 210 and the set of LEDs 220 can be covered by a clear glass 230, wherein the clear glass 230 can be designed such that it may cover an external region of the housing 210. Finally, a set of colored tapes 240 can be applied over the entire region of the housing 210 in order to provide visible indication of the elevated airport light color, especially during non-operation state.

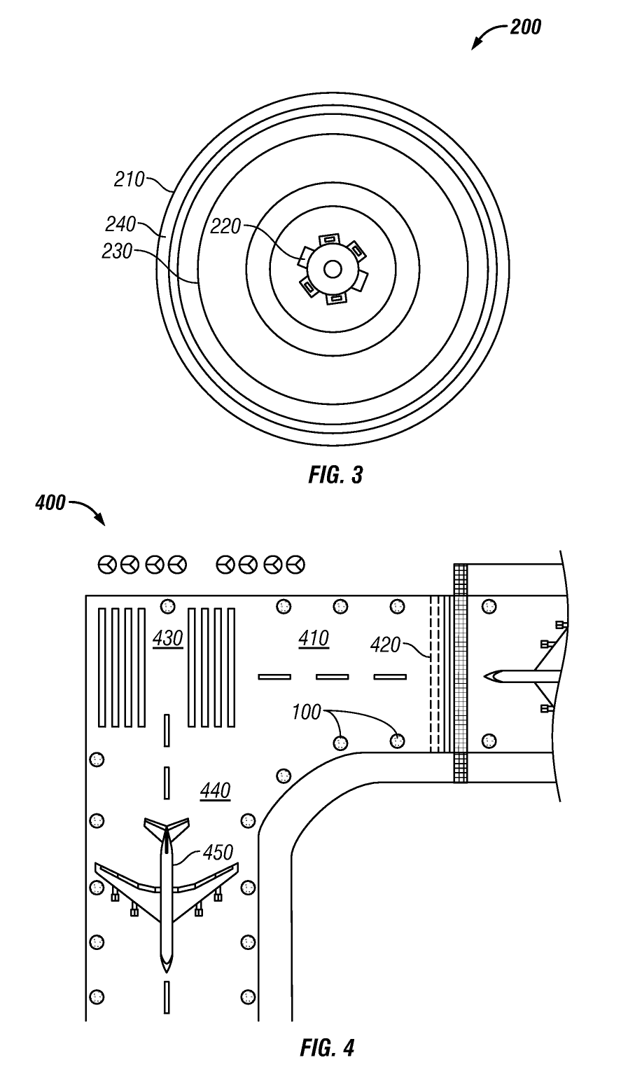

FIG. 3 illustrates a top view of the elevated airport light 200, as shown in FIG. 2, in accordance with an alternative embodiment. Note that in FIGS. 2-3 identical parts or elements are generally indicated by identical reference numerals. The set of LEDs 220 can be centrally arranged within the housing 210 in a circular fashion in order to emit light in different angles. The clear glass 230 can protect the set of LEDs 220 from external affairs, which maintains the precision optical performance of the LEDs 220 and may as well protect the colored tapes 240.

In addition, these colored tapes 240 can also be applicable to bi-directional elevated lights 200, where the tape 240 can be one color on one side of the elevated light 200 and a different color on the other side of the elevated light 200. The elevated airport light 200 can also be accomplished by applying paint to the appropriate area of the housing 210, in the event that the housing shape cannot permit the application of colored tape 240. Hence, the regulations can be met, while reducing product cost, by substituting clear glass 230 with the colored tapes 240 for the more expensive colored glass and by increasing the number of the clear glass 230 covers purchased as compared to the individual numbers of the various colored glass covers.

FIG. 4 illustrates a top plan view of an airport runway light system 400 incorporating elevated airport lights 100 and 200 constructed and arranged in accordance with a preferred embodiment. The elevated airport lights 100 and 200 can be installed on a side of a runway/taxiway 410 and/or near to a hold line 420 for a runway entrance control at a controlled or uncontrolled airfield. The elevated airport lights 100 and 200 with the colored tapes 140 and 240 can provide a clear indication to the runway/taxiway 410, or an intersection 430 of the runway 410 with another runway/taxiway 440, even during the non-operation condition. These elevated airport lights 100 and 200 can guide pilots to drive airplanes 450 in the runways/taxiways 410 and 440 after reaching a runway holding position identified by the hold line 420. The elevated airport lights 100 and 200 can be electrically coupled to electrical systems (not shown) of the airport runway light system 400.

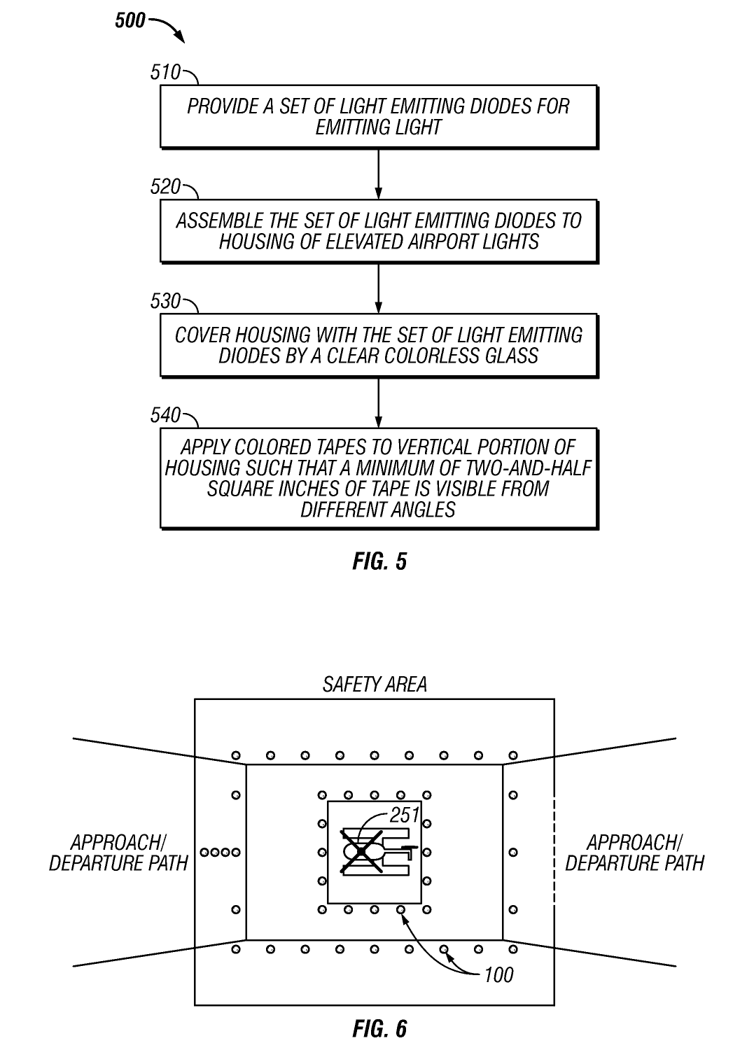

FIG. 5 illustrates a flow chart of a method 500 for providing visible indication of elevated airport light color, in accordance with a preferred embodiment. As illustrated at block 510, a set of light emitting diodes (LEDs) 120 can be provided for emitting light in the runway/taxiway 410 and 440, as illustrated in FIG. 4. As described at block 520, the set of LEDs 120 can be assembled to the housing 110 of the elevated airport lights 100. As specified at block 530, the housing 110 with the set of LEDs 120 can be covered by the clear colorless glass 130. Finally, as depicted at block 540, several colored tapes 140 can be applied to the vertical portion 131 of the housing 110 such that a minimum portion (e.g., two-and-half square inches) of the tape 140 is visible from different angles. Such a colored tape 140 can provide the visible indication of the elevated airport light color during a non-operation condition without utilizing more expensive colored glass and/or lens.

FIG. 6 illustrates a top plan view of a heliport landing area lighting system incorporating elevated airport lights constructed and arranged in accordance with an alternative embodiment. Note that in FIGS. 1-6, identical or similar parts or elements are generally indicated by identical reference numerals. In the configuration depicted in FIG. 6, rather than an airport runway and airplane as indicated in FIGS. 1-5, for example, the present invention can be embodied in the context of a heliport landing area lighting system for guiding a helicopter 251 along an appropriate approach/departure path to an appropriate landing area. A number of elevated airport lights 100 can be implemented within the context of the design depicted in FIG. 6. The elevated airport/heliport light apparatus 100 can thus be implemented in association with a number of runway light and heliport touchdown and lift-off (TLOF)/final approach and take-off (FATO) lighting systems.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

What is claimed is:

1. A method for providing a visible indication of elevated airport light color during a non-operational condition, comprising:
assembling at least one light emitting diode to a housing of an elevated airport light, wherein said at least one light emitting diode is elevated above a surface of a ground utilizing a mast;
covering said housing and said at least one light emitting diode by a clear glass, wherein said clear glass is configured to cover an outer region of said housing and encompass said at least one light emitting diode; and
applying at least one colored tape to a particular area of said housing such that a minimum portion of said at least one colored tape is visible from a plurality of angles, thereby providing a clear visible indication of elevated airport light color during a non-operational condition without a need for expensive colored glass and/or a colored lens.

2. The method of claim 1 wherein said at least one colored tape comprises a color of light emitted from said at least one light emitting diode.

3. The method of claim 1 further comprising:
configuring said elevated airport light to comprise a bi-directional elevated airport light; and
adapting said at least one colored tape for use with said bi-directional elevated airport light.

4. The method of claim 1 further comprising configuring said elevated airport light by applying a paint to said outer region of said housing.

5. The method of claim 1 further comprising mounting said mast to a base plate via a frangible coupling.

6. The method of claim 1 further comprising installing said elevated airport light on a side of a runway.

7. The method of claim 1 further comprising installing said elevated airport light on a side of a taxiway.

8. The method of claim 1 further comprising configuring said at least one colored tape with a reflective property.

9. The method of claim 1 further comprising configuring said at least one colored tape with a non-reflective property.

10. The method of claim 1 further comprising covering said at least one colored tape with said glass cover.

11. An apparatus for providing a visible indication of elevated airport light color during a non-operational condition, comprising:
at least one light emitting diode assembled to a housing of an elevated airport light, wherein said at least one light emitting diode is elevated above a surface of a ground utilizing a mast;
a clear glass that covers said housing and said at least one light emitting diode, wherein said clear glass covers an outer region of said housing and encompasses said at least one light emitting diode; and
at least one colored tape applicable to a particular area of said housing such that a minimum portion of said at least one colored tape is visible from a plurality of angles, thereby providing a clear visible indication of elevated airport light color during a non-operational condition without a need for expensive colored glass and/or a colored lens.

12. The apparatus of claim 11 wherein said at least one colored tape comprises a color of light emitted from said at least one light emitting diode.

13. The apparatus of claim 11 wherein:
said elevated airport light comprises a bi-directional elevated airport light; and
said at least one colored tape is adapted for use with said bi-directional elevated airport light.

14. The apparatus of claim 11 wherein said elevated airport light is configured by applying a paint to said outer region of said housing.

15. The apparatus of claim 11 said mast is mounted to a base plate via a frangible coupling.

16. The apparatus of claim 11 wherein said at least one colored tape includes a reflective property.

17. The apparatus of claim 11 wherein said at least one colored tape includes a non-reflective property.

18. The apparatus of claim 11 wherein said at least one colored tape is covered with said glass cover.

19. An apparatus for providing a visible indication of elevated airport light color during a non-operational condition, comprising:
at least one light emitting diode assembled to a housing of an elevated airport light, wherein said at least one light emitting diode is elevated above a surface of a ground utilizing a mast;
a clear glass that covers said housing and said at least one light emitting diode, wherein said clear glass covers an outer region of said housing and encompasses said at least one light emitting diode; and
at least one colored tape applicable to a particular area of said housing such that a minimum portion of said at least one colored tape is visible from a plurality of angles, wherein said at least one colored tape comprises a color of light emitted from said at least one light emitting diode, thereby providing a clear visible indication of elevated airport light color during a non-operational condition without a need for expensive colored glass and/or a colored lens.

20. The apparatus of claim 19 wherein:
said elevated airport light comprises a bi-directional elevated airport light; and
said at least one colored tape is adapted for use with said bi-directional elevated airport light;
said elevated airport light is configured by applying a paint to said outer region of said housing.
